(19) United States
(12) Patent Application Publication
(10) Pub. No.: US 2007/0171463 A1
(43) Pub. Date: Jul. 26, 2007

(54) Network printer system, printer, control method for computer, computer readable medium and computer data signal

(75) Inventors: Takanari Ishimura, Saitama-shi (JP); Yuriko Inakawa, Saitama-shi (JP); Atsuhiro Itoh, Saitama-shi (JP); Fumio Harada, Saitama-shi (JP); Jun Wakamatsu, Saitama-shi (JP); Noriyuki Tatsuma, Saitama-shi (JP); Akira Okamoto, Saitama-shi (JP); Masaki Kurokawa, Saitama-shi (JP); Eiji Nishi, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Minato-ku (JP)

(21) Appl. No.: 11/501,813

(22) Filed: Aug. 10, 2006

(30) Foreign Application Priority Data
Jan. 23, 2006 (JP) 2006-014410

(51) Int. Cl. G06F 3/12

(52) U.S. Cl. 358/1.15; 358/1.14

(57) ABSTRACT

A network printer system comprises a first printer and a second printer. The first printer comprises: a first network setting information storing unit that stores setting information of a previously designated network; a radio communication establishing unit that establishes a radio communication with the second printer; and a network setting information transmitting unit that transmits the stored setting information of the network to the second printer by the established radio communication. The second printer comprises: a network setting information receiving unit that receives the setting information of the network transmitted by the network setting information transmitting unit; a second network setting information storing unit that stores the received setting information of the network; and a unit that switches the setting of the network in accordance with the stored setting information of the network.

### BACKGROUND

(i) Technical Field

The present invention relates to a network printer system for setting a network of a printer, a printer, a control method for a computer, a computer readable medium and computer data signal.

(ii) Related Art

In recent years, a network printer has been known that includes a radio LAN interface and is connected to a local area network by a radio communication. When the network printer is connected to the local area network by using the radio LAN interface, the network printer needs to have a setting that meets an environment of the local area network. However, the user interface of a display device or an input device provided in the printer is lower in its maneuverability than a PC or the like, so that it is difficult to set the network. Further, an erroneous input of a setting is liable to arise. Thus, the network of the printer is ordinarily set through a computer such as the PC connected to the printer.

### SUMMARY

A network printer system according to the present invention comprises a first printer; and a second printer, wherein the first printer comprises: a first network setting information storing unit that stores setting information of a previously designated network; a radio communication establishing unit that establishes a radio communication with the second printer; and a network setting information transmitting unit that transmits the setting information of the network stored in the first network setting information storing unit to the second printer by the radio communication established by the radio communication establishing unit, and wherein the second printer comprises: a network setting information receiving unit that receives the setting information of the network transmitted by the network setting information transmitting unit; a second network setting information storing unit that stores the setting information of the network received by the network setting information receiving unit; and a unit that switches the setting of the network in accordance with the setting information of the network stored in the second network setting information storing unit.

### BRIEF DESCRIPTION OF THE DRAWINGS

Exemplary embodiment(s) of the present invention will be described in detail based on the following figures, wherein:

FIG. 1 is a system block diagram of a network system including a printer system according to an embodiment of the present invention;

FIG. 2 is a hardware block diagram of a network printer system;

FIG. 3 is a functional block diagram of the network printer system; and

FIG. 4 is a sequence diagram of a network setting process in the network printer system.

### DETAILED DESCRIPTION

Now, an exemplary embodiment of the present invention will be described in detail by referring to the drawings.

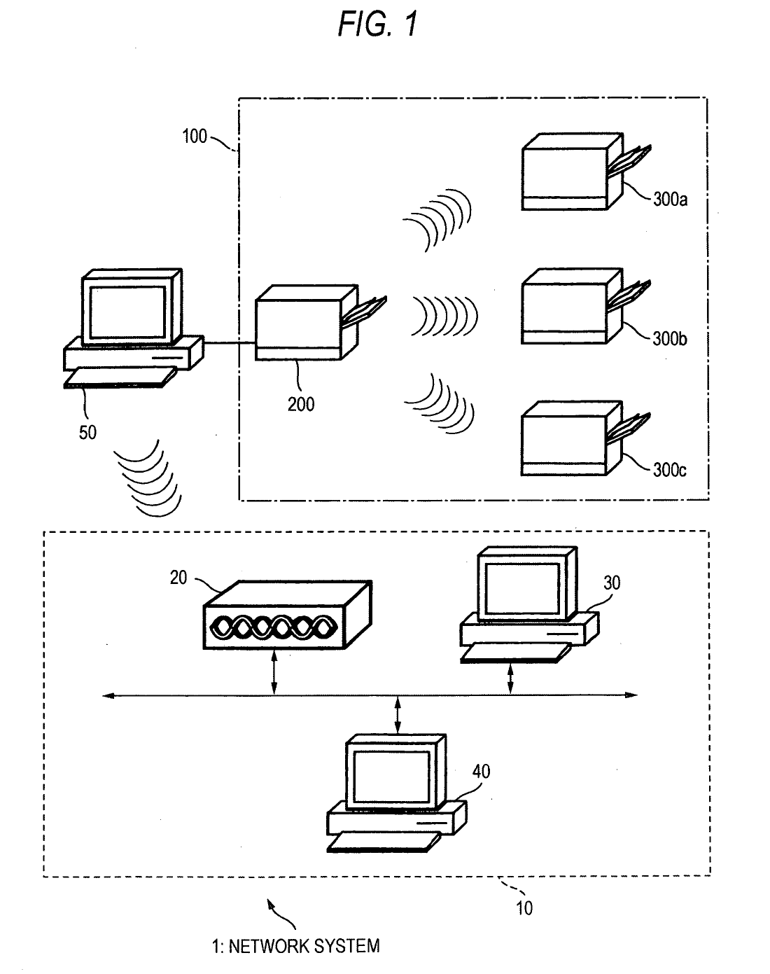

FIG. 1 shows a system block diagram of a network system including a printer system according to an exemplary embodiment of the present invention. As shown in FIG. 1, the network system 1 includes a local area network system 10, a network printer system 100 and PCs.

The local area network system 10 includes an access point 20 or PCs 30 and 40 or the like and is a system for forming a local area network. An external device such as a setting PC 50 is connected to the local area network system 10 through the access point 20 by a radio communication. To communicate with the access point 20 by the radio communication, a network setting of SSID, WEP keys, etc. needs to correspond to the setting of the access point 20.

The network printer system 100 includes a first printer 200 and at least one second printer. In this exemplary embodiment, as the second printers, three printers 300a, 300b and 300c are included. However, the present invention is not limited thereto. The first printer and the second printer 300 are printers respectively including radio LAN interfaces and having radio communication functions. In this exemplary embodiment, a network setting of the first printer 200 for connecting the printer to the local area network system 10 is performed by the setting PC 50. Then, to the second printer 300, network setting information for connecting the printer to the local area network system 10 is supplied from the first printer 200 by the radio communication. In such a way, the first printer 200 and the second printers 300a, 300b and 300c can perform a radio communication with a device included in the local area network system 10.

In the first printer 200, the network is set by the setting PC 50 to be connected to the printer. Then, the first printer 200 supplies the setting information of the set network to the second printers 300a, 300b and 300c. As described above, the setting information of the network mentioned herein means a setting for performing a radio communication with the access point 20. The first printer 200 is connected to the setting PC 50 through a serial connection such as a USB or a network connection of Etha net (registered trademark).

The second printer 300 receives the distribution of the setting information of the network from the first printer 200. The second printer 300 is connected to the first printer 200 by the radio communication to receive the setting information of the network. Then, the second printer 300 switches the setting of the network in accordance with the received network setting information. Thus, the second printer 300 can perform a radio communication with the access point 20 so that the second printer can carry out a data communication with the PCs 30 and 40 included in the local area network system 10.

A structure provided in the network printer system 100 to realize the above-described processes will be described below. In this exemplary embodiment, the second printer 300 includes three printers, however, since the operations of the printers are respectively the same, the second printer 300a is adopted as a representative printer and explained below.

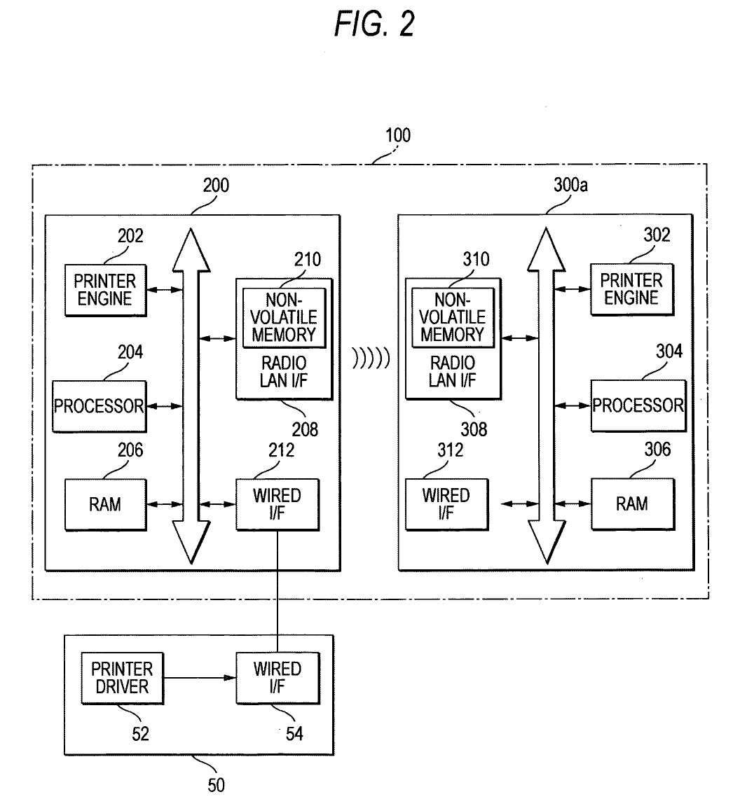

FIG. 2 shows a block diagram of hardware of the network printer system 100. As shown in FIG. 2, the first printer 200 physically includes a printer engine 202, a processor 204, a RAM 206, a radio LAN interface 208, a non-volatile memory 210 and a wired interface 212. The second printer 300a also physically includes a printer engine 302, a processor 304, a RAM 306, a radio LAN interface 308, a non-volatile memory 310 and a wired interface 312. In this exemplary embodiment, since the structure of the hardware of the first printer 200 is the same as that of the second printer 300a, the parts only of the first printer 200 are respectively described below.

The printer engine 202 is hardware for forming an image. The printer engine 202 performs physical printing processes, for instance, feeding sheets or electrifying a drum, applying a laser, applying toner, transferring an image to a sheet, fixing toner, or the like.

The processor 204 controls the respective parts of the first printer 200 in accordance with a control program stored in a ROM that is not shown in the drawing or a program read from the RAM 206. Further, in the RAM 206, a program or data is written as required and the RAM 206 is also used for an operation of the processor 204.

The wired interface 212 is an interface for performing a wired communication with an external device. As shown in FIG. 2, the first printer 200 is connected to the setting PC 50 by a cable for connecting the wired interface 212 of the first printer 200 to the wired interface 54 of the setting PC 50. Further, in this exemplary embodiment, the wired interface 212 is an interface of a serial connection such as a USB, however, the present invention is not limited thereto and the wired interface 212 may be an interface of a network connection such as Etha net (registered trademark).

The radio LAN interface 208 is a network interface for performing a radio communication with an external device. The radio LAN interface 208 includes the non-volatile memory 210 and the setting information of the network is stored in the non-volatile memory 210. The network setting information is composed of the information of, for instance, an SSID of a radio network, a WEP key set to the radio network, a channel frequency, etc. In this exemplary embodiment, the network setting information of the radio LAN interface 208 is generated by a printer driver 52 of the setting PC 50 to be connected thereto. Then, the first printer 200 receives the network setting information through the wired interface 212.

The radio LAN interface 208 operates by two communication modes. A first communication mode is an add-hook mode. In the add-hook mode, a radio communication is established with another radio LAN interface on a 1 to 1 basis to realize a data communication. Further, a second communication mode is an infrastructure mode. In the infrastructure mode, the data communication is carried out with other device connected to the access point 20 by a radio communication through the access point 20. The communication mode of the radio LAN interface 208 is designated by the network setting information.

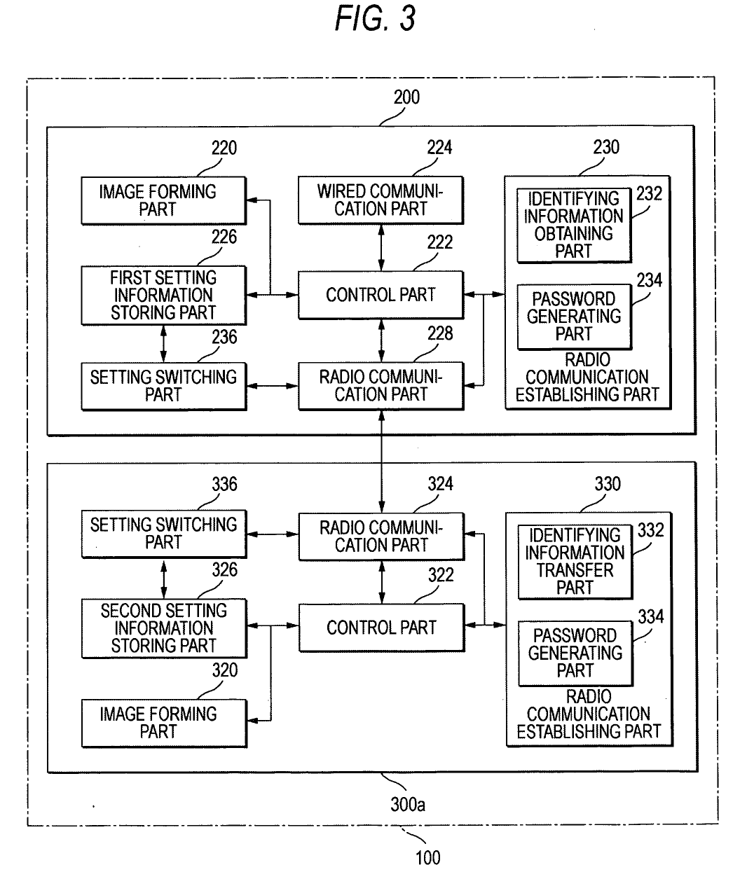

FIG. 3 shows a functional block diagram of the network printer system 100. Now, the functional blocks of the printer 200 and the second printer 300a will be described below in order. As shown in FIG. 3, the first printer 200 functionally includes an image forming part 220, a control part 222, a wired communication part 224, a first setting information storing part 226, a radio communication part 228, a radio communication establishing part 230 and a setting switching part 236. Further, the radio communication establishing part 230 includes an identifying information obtaining part 232 and a password generating part 234.

The image forming part 220 has a function for forming an image in accordance with received print data. The image forming part 220 designates a function realized by the printer engine 202 of the first printer 200.

The control part 222 has a function for respectively controlling the parts of the first printer 200 or the timings of processes. The control part 222 designates a function realized by the processor 204 and the RAM 206 of the first printer 200 and the control program.

The wired communication part 224 has a function for performing a data communication by wire. The wired communication part 224 is a function realized by the wired interface 212 of the first printer 200. In this exemplary embodiment, the wired interface 212 is a USB interface and the first printer 200 performs a data communication with the setting PC 50 through a USB cable. However, the present invention is not limited thereto and the printer 200 may perform a data communication by the network connection such as the Etha net (registered trademark). Further, in data received from the setting PC 50 by the wired communication part 224, the network setting information of the radio LAN interface 208 is included.

The first setting information storing part 226 has a function for storing the network setting information received by the wired communication part 224. The first setting information storing part 226 is a function realized by a storing part such as the RAM 206 of the first printer 200. The processor 204 of the first printer 200 stores the setting information of the printer received by the wired communication part 224 in the RAM 206.

The radio communication part 228 has a function for performing a radio data communication. The radio communication part 228 is a function realized by the radio LAN interface 208 of the first printer 200. The radio communication may correspond to “IEEE802. 11b/g/a” of a radio LAN standard. The radio communication part 228 performs the radio communication in accordance with the setting information stored in the non-volatile memory 210 of the radio LAN interface 208. In the setting information, the information of SSID, the WEP key and the communication mode is included. The SSID is a character string set to a radio network. The SSID is set to perform a communication between devices having the same SSID. Further, the WEP key is a network password set to an encoded radio network. For the WEP key, a bit length such as 64 bits, 128 bits or the like is used. The communication mode indicates information for designating an adopted radio LAN standard such as the “IEEE802. 11b/g/a”.

The radio communication establishing part 230 has a function for establishing the radio communication with the external device. In this exemplary embodiment, the radio communication establishing part 230 establishes the radio communication by the add-hook mode of the first printer 200 and the second printer 300a. The radio communication establishing part 230 is realized by using the hardware of the first printer 200 as described below. When the first printer 200 is initially set to a mode in which the first printer operates as a master for supplying the setting of the network by a user, the first printer sets the communication mode of the radio LAN interface 208 to the add-hook mode and other setting information to a default state (a state of shipping from a factory). Then, the first printer establishes the radio communication by the add-hook mode with the second printer 300a in which the same network setting is performed. Further, the radio communication establishing part 230 performs a process for strengthening the security of the previously established radio communication by the identifying information obtaining part 232 and the password generating part 234.

The identifying information obtaining part 232 has a function for obtaining the identifying information of the second printer 300a by the radio communication previously established by the radio communication establishing part 230. In this exemplary embodiment, for the identifying information of the second printer 300a, a serial number of the second printer 300a is used. Then, the processor 204 of the first printer 200 stores the serial number transferred by the previously established radio communication.

The password generating part 234 has a function for generating a network password by applying an encoding process using a common algorithm to the first printer 200 and the second printer 300a to the identifying information obtained in the identifying information obtaining part 232. The password generating part 234 may use an encoding process of a common key encoding system as the encoding method common to the first printer 200 and the second printer 300a. The first printer 200 encodes the obtained identifying information of the second printer 300a by using the common key to the first printer 200 and the second printer 300a to generate a key. Further, the second printer 300a also encodes its own identifying information by using the common key to generate a key. The password generating part 234 generates a WEP key (for instance, a bit length of 128 bits) used for encoding an add-hook network. Here, since both the first printer 200 and the second printer 300a apply the encoding process using the common key to the same identifying information, the generated keys are the same.

Then, the radio communication establishing part 230 uses the WEP key generated in the password generating part 234 to update the WEP key of the radio communication previously established in the first printer 200 and the second printer 300a. In such a way, under a state that the security is strengthened, the first printer 200 and the second printer 300a can perform the radio communication with each other.

The first printer 200 transmits the setting information of the network for connecting the printer to the local area network system 10 stored in the first setting information storing part 226 to the second printer 300a through the radio LAN interface 208 by the radio communication established as described above.

Further, the setting switching part 236 has a function for switching the setting of the network in accordance with the setting information of the network stored in the first setting information storing part 226 after the transmission of the setting information of the network is completed. The setting switching part 236 is realized by using the hardware of the first printer 200 as described below. When the processor 204 of the first printer 200 receives a signal showing that the transmission of the network setting information to the second printer 300a is normally completed through the radio LAN interface 208, the processor reads the network setting information stored in the RAM 206 to update the value of the setting information on the non-volatile memory 210 of the radio LAN interface 208.

Further, the second printer 300a functionally includes an image forming part 320, a control part 322, a radio communication part 324, a second setting information storing part 326, a radio communication establishing part 330 and a setting switching part 336. The radio communication establishing part 330 includes an identifying information transfer part 332 and a password generating part 334. Since the image forming part 320, the control part 322 and the radio communication part 324 have the same functions as those described in the first printer 200, an explanation thereof is omitted. Now, the second setting information storing part 326, the radio communication establishing part 330 and the setting switching part 336 will be respectively described below.

The radio communication establishing part 330 has a function for establishing the radio communication. In this exemplary embodiment, the radio communication establishing part 330 establishes the radio communication of the add-hook mode with the first printer 200. The radio communication establishing part 330 is realized by using the hardware of the second printer 300a as described below. When the second printer 300a is firstly set to a mode operating as a slave that receives the distribution of the setting of the network by the user, the second printer 300a sets the communication mode of the radio LAN interface 308 to the add-hook mode and other setting information to a default state (a state of shipping from a factory). Then, the second printer 300a establishes the radio communication of the add-hook mode with the first printer 200 set in the same manner as that of the second printer.

The identifying information transfer part 332 has a function for transferring the identifying information of the second printer 300a to the first printer 200 by the radio communication previously established in the radio communication establishing part 330. In this exemplary embodiment, the identifying information transfer part 332 transfers a serial number as the identifying information of the second printer 300a. The processor of the second printer 300a obtains the serial number from the hardware setting information of the second printer 300a to transfer the obtained serial number through the radio LAN interface 308.

The password generating part 334 has a function for generating a common network password (a WEP key) by applying an encoding process common to the first printer 200 and the second printer 300a to the identifying information transferred by the identifying information transfer part 332. Since the processes of the password generating part 334 are the same as the processes of the password generating part 234 in the first printer 200, an explanation thereof will be omitted below.

Then, the radio communication establishing part 330 uses the WEP key generated in the password generating part 334 to update the WEP key of the radio communication previously established in the first printer 200 and the second printer 300a. Thus, the radio communication is established again.

The second printer 300a receives the setting information of the network transmitted from the first printer 200 by the radio communication part 324 in accordance with the radio communication established in the radio communication establishing part 330. Then, the second printer 300a stores the received setting information of the network in the second setting information storing part 326. The second setting information storing part 326 is a function realized by the RAM 306 of the second printer 300a.

The setting switching part 336 has a function for switching the setting of the network in accordance with the setting information of the network stored in the second setting information storing part 326. The setting switching part 336 is realized by using the hardware of the second printer 300a as described below. The processor 304 obtains the setting information of the network from the RAM 306. Then, the processor 304 updates the setting information of the non-volatile memory 310 of the radio LAN interface 308 in accordance with the obtained setting information of the network. The radio LAN interface 308 starts an operation on the basis of the updated setting information.

Now, the detail of an operation of a network setting process in the network printer system 100 according to the exemplary embodiment of the present invention will be described below.

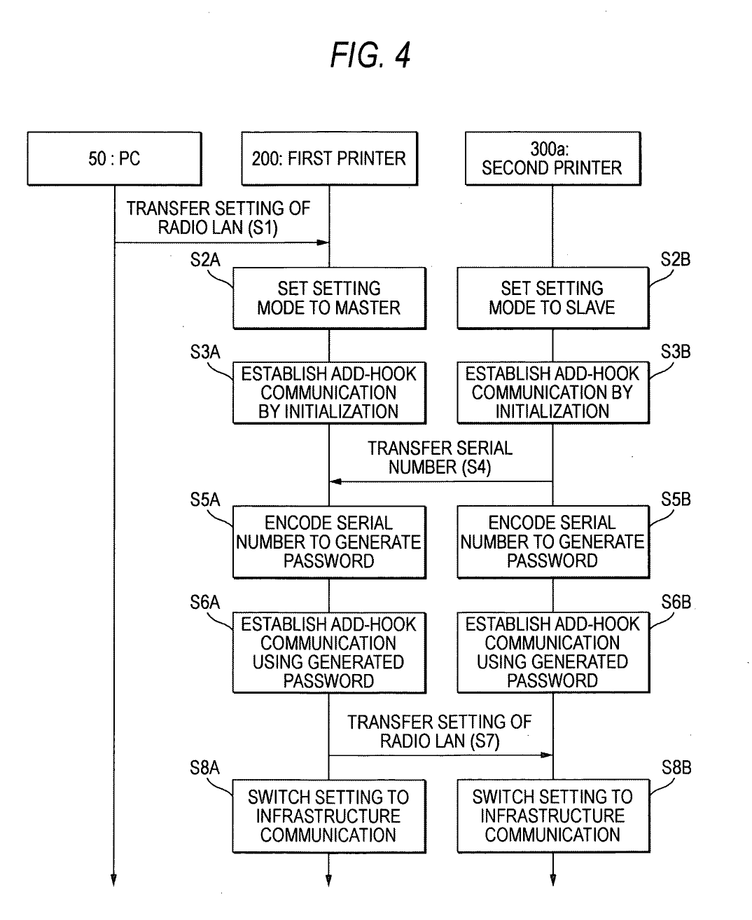

FIG. 4 shows a sequence diagram of the network setting process in the network printer system 100. As shown in FIG. 4, to the first printer 200, the network setting information for performing the radio communication with the access point 20 is transferred from the setting PC 50 connected to the first printer (S1). Then, the setting mode of the first printer 200 is set to a side (a master side) for supplying the setting of the network by the user (S2A). Then, the setting mode of the second printer 300a is set to a side (a slave side) for receiving the supply of the setting of the network by the user (S2B). The first printer 200 and the second printer 300a switch the communication modes of the radio LAN interfaces to the add-hook modes and set the parameters of other radio LAN interfaces to the values of initial states to establish the radio communication of the add-hook mode (S3A, S3B). Then, the second printer 300a transfers a serial number thereof to the first printer 200 by the established radio communication (S4). The first printer 200 applies the common encoding process to the received serial number to generate the WEP key (S5A). Further, the second printer 300a also applies the common encoding process to the serial number thereof to generate the WEP key (S5B). Then, the first printer 200 and the second printer 300a establish the radio communication of the add-hook mode again by using the generated WEP keys (S6A, S6B). The first printer 200 transfers the received network setting information to the second printer 300a by the radio communication established in S6A and S6B (S7). When the setting information of the network is completely transferred, the first printer 200 switches the setting of the radio communication to the infrastructure mode from the add-hook mode in accordance with the network setting received from the setting PC 50 (S8A). Further, when the second printer 300a completely receives the setting information of the network, the second printer 300a switches the setting of the radio communication to the infrastructure mode from the add-hook mode in accordance with the setting information of the network received from the first printer 200 (S8B).

According to the network printer system of the above-described exemplary embodiment of the present invention, below-described effects can be obtained. Firstly, the network setting of the radio LAN for a plurality of printers can be performed without an erroneous input. Secondly, the security of the network setting of the radio LAN can be sufficiently ensured and transferred between the printers. Thirdly, since the network setting is transferred between the printers, an inconvenience resulting from the version of software that arises, for instance, when the OS of a PC is upgraded does not occur as compared with a case in which the network setting is transferred to the printer by the PC. In accordance with the above-described effects, the network printer system of the exemplary embodiment of the present invention can reduce a time and labor for setting the network of the printer.

The present invention is not limited to the above-described exemplary embodiment.

In the above-described exemplary embodiment, for establishing the radio communication, the radio communication is reestablished by using the WEP key generated by the use of the identifying information of the second printer, however, the setting information of the network may be transferred to the second printer from the first printer by the radio communication initially established by an initialization.

Further, in the above-described exemplary embodiment, when the setting information of the network is transferred to the second printer from the first printer, an infrared ray communication may be employed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A network printer system comprising:
a first printer; and
a second printer,
wherein the first printer comprises:
a first network setting information storing unit that stores setting information of a previously designated network;
a radio communication establishing unit that establishes a radio communication with the second printer; and
a network setting information transmitting unit that transmits the setting information of the network stored in the first network setting information storing unit to the second printer by the radio communication established by the radio communication establishing unit, and
wherein the second printer comprises:
a network setting information receiving unit that receives the setting information of the network transmitted by the network setting information transmitting unit;
a second network setting information storing unit that stores the setting information of the network received by the network setting information receiving unit; and
a unit that switches the setting of the network in accordance with the setting information of the network stored in the second network setting information storing unit.

2. A network printer system according to claim 1,
wherein the first printer further comprises:
a unit that switches the setting of the network in accordance with the setting information of the network stored in the first network setting information storing unit after the transmission of the setting information of the network is completed by the network setting information transmitting unit.

3. A network printer system according to claim 1,
wherein the radio communication establishing unit comprises:
an identifying information obtaining unit that obtains the identifying information of the second printer; and
a password generating unit that generates a common network password by performing an encoding process common to the first printer and the second printer to the identifying information obtained by the identifying information obtaining unit, and
wherein the radio communication establishing unit establishes the radio communication with the second printer by using the network password generated by the password generating unit.

4. A network printer system according to claim 1,
wherein the radio communication establishing unit establishes a radio communication of an add-hook mode with the second printer.

5. A printer that stores setting information of a previously designated network, the printer comprising:
a radio communication establishing unit that establishes a radio communication with other printer; and
a network setting information transmitting unit that transmits the setting information of the network to other printer by the radio communication established by the radio communication establishing unit.

6. A control method for a computer that stores setting information of a previously designated network, the method comprising:
establishing a radio communication with a printer; and
transmitting the setting information of the network to the printer by the established radio communication.

7. A computer readable medium storing a program causing a computer that stores setting information of a previously designated network to execute a process comprising:
establishing a radio communication with a printer; and
transmitting the setting information of the network to the printer by the established radio communication.

8. An image forming device comprising:
a radio communication establishing unit that establishes a radio communication with a printer that stores setting information of a previously designated network;
a network setting information receiving unit that receiving the setting information of the network from the printer by the radio communication established by the radio communication establishing unit;
a network setting information storing unit that stores the setting information of the network received by the network setting information receiving unit; and
a unit that switches the setting of the network in accordance with the setting information of the network stored in the network setting information storing unit.

9. A control method for a computer comprising:
establishing a radio communication with a printer that stores setting information of a previously designated network;
receiving the setting information of the network from the printer by the established radio communication;
storing the received setting information of the network; and
switching the setting of the network in accordance with the stored setting information of the network.

10. A computer readable medium storing a program causing a computer to execute a process comprising:
establishing a radio communication with a printer that stores the setting information of a previously designated network;
receiving the setting information of the network from the printer by the established radio communication;
storing the received setting information of the network; and
switching the setting of the network in accordance with the stored setting information of the network.

11. A computer data signal embodied in a carrier wave for enabling a computer to perform a process comprising:
establishing a radio communication with a printer; and
transmitting the setting information of the network to the printer by the established radio communication.

12. A computer data signal embodied in a carrier wave for enabling a computer to perform a process comprising:
establishing a radio communication with a printer that stores the setting information of a previously designated network;
receiving the setting information of the network from the printer by the established radio communication;
storing the received setting information of the network; and
switching the setting of the network in accordance with the stored setting information of the network.
